(19) United States
(12) Patent Application Publication
(10) Pub. No.: US 2022/0075881 A1
(43) Pub. Date: Mar. 10, 2022

(54) Information Processing Apparatus, Information Processing Method, and Information Processing Program

(71) Applicant: SONY GROUP CORPORATION, TOKYO (JP)

(72) Inventors: YUICHIRO KOYAMA, TOKYO (JP); KAZUYA TATEISHI, KANAGAWA (JP); HIROAKI OGAWA, TOKYO (JP); CHIE KAMADA, TOKYO (JP); EMIRU TSUNOO, TOKYO (JP); NORIKO TOTSUKA, TOKYO (JP); YUKI TAKEDA, TOKYO (JP); KAN KURODA, TOKYO (JP); AKIRA TAKAHASHI, TOKYO (JP); YOSHINORI MAEDA, TOKYO (JP); AKIRA FUKUI, TOKYO (JP); HIDEAKI WATANABE, TOKYO (JP)

(21) Appl. No.: 17/310,778

(22) PCT Filed: Jan. 24, 2020
(86) PCT No.: PCT/JP2020/002496

§ 371 Date: Aug. 24, 2021

(30) Foreign Application Priority Data
Mar. 1, 2019 (JP) 2019-037221

(51) Int. Cl. G06F 21/60; G06F 21/62

(52) U.S. Cl. CPC G06F 21/604; G06F 2221/2141; G06F 2221/2117; G06F 21/6245

(57) ABSTRACT

An information processing apparatus includes a behavior detector that detects a behavior performed by a user when the user makes a request to an information providing apparatus with respect to information from the user, and a response determination section that determines a response to be made by the information providing apparatus to the request.

### TECHNICAL FIELD

The present technology relates to an information processing apparatus, an information processing method, and an information processing program.

### BACKGROUND ART

In recent years, devices such as a smart speaker and a communication robot that provide various information in response to a request from a user have started being widely used. Various information can be stored in such a device, and a user may store, in the device, his/her own personal information, confidential information that the user does not want other people to know about, and the like.

It is important that the anonymity and the confidentiality be retained in a device that deals with information that a user wants to keep secret, such that the information is not leaked. Thus, a technology has been proposed that is used to retain the anonymity such that personal information such as information regarding user's preference is not leaked (Patent Literature 1).

### CITATION LIST

### Patent Literature

Patent Literature 1: Japanese Patent Application Laid-open No. 2005-149126

### DISCLOSURE OF INVENTION

### Technical Problem

However, the technology disclosed in Patent Literature 1 does not provide any method for explicitly informing that it is information that a user wants to keep secret. Further, the technology disclosed in Patent Literature 1 does not provide any method for outputting secret information when there is a need to output the information. Those are unsolved problems.

The present technology has been made in view of the circumstances described above, and it is an object of the present technology to provide an information processing apparatus, an information processing method, and an information processing program that make it possible to make a response to a request made by a user that information be kept secret, and to a request made by the user that information be disclosed.

### Solution to Problem

In order to solve the problems described above, a first technology is an information processing apparatus that includes a behavior detector that detects a behavior performed by a user when the user makes a request to an information providing apparatus with respect to information from the user, and a response determination section that determines a response to be made by the information providing apparatus to the request.

Further, a second technology is an information processing method that including detecting a behavior performed by a user when the user makes a request to an information providing apparatus with respect to information from the user, and determining a response to be made by the information providing apparatus to the request.

Furthermore, a third technology is an information processing program that causes a computer to perform an information processing method including detecting a behavior performed by a user when the user makes a request to an information providing apparatus with respect to information from the user, and determining a response to be made by the information providing apparatus to the request.

### BRIEF DESCRIPTION OF DRAWINGS

FIG. 1 illustrates a configuration of an appearance of an information providing apparatus 100.

FIG. 2 illustrates an example of a space in which the information providing apparatus 100 is used.

FIG. 3 is a block diagram illustrating a configuration of the information providing apparatus 100.

FIG. 4 is a block diagram illustrating a configuration of an information processing apparatus 200.

FIG. 5 is a diagram describing confidential information.

A of FIG. 6 illustrates an example of a message indicating completion of registration of confidential information, and B and C of FIG. 6 illustrate examples of a message used to encourage registration of an unregistered item of the confidential information.

FIG. 7 is a flowchart illustrating processing performed in response to a request from a user.

FIG. 8 is a flowchart illustrating processing of registering confidential information.

FIG. 9 is a flowchart illustrating processing of limitedly providing information.

FIG. 10 is a block diagram illustrating a configuration of an IoT device.

FIG. 11 illustrates a configuration of an information sharing system that includes a server.

FIG. 12 illustrates a user interface used for information sharing.

FIG. 13 illustrating confidential information being diverted to be shared.

### MODE(S) FOR CARRYING OUT THE INVENTION

Embodiments of the present technology will now be described below with reference to the drawings. Note that the description is made in the following order.
<1. Embodiments>
[1-1. Configuration of Information Providing Apparatus 100]
[1-2. Configuration of Information Processing Apparatus 200]
[1-3. Processing Performed by Information Processing Apparatus 200]
[1-3-1. Processing Performed in Response to Request from User]
[1-3-2. Processing of Registering Confidential Information]
[1-3-3. Processing of Limitedly Providing Information]
[1-3-4. Sharing of Confidential Information]
<2. Modifications>

<1. Embodiments>

[1-1. Configuration of Information Providing Apparatus 100]

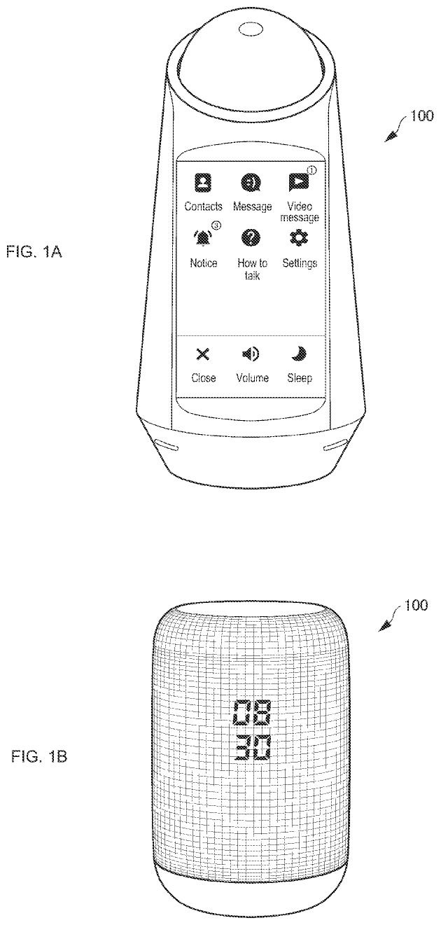

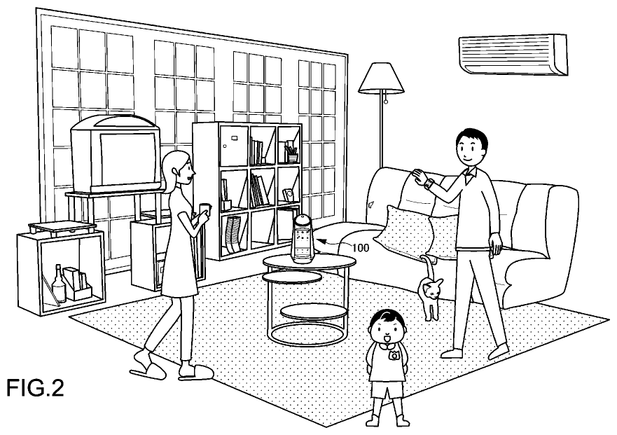

First, a configuration of an information providing apparatus 100 that includes a function of an information processing apparatus 200 according to the present technology is described. The information processing apparatus 200 operates in the information providing apparatus 100. Examples of the information providing apparatus 100 include a so-called communication robot illustrated in A of FIG. 1 and a so-called smart speaker illustrated in B of FIG. 1 that are capable of providing various information to a user in response to a request from the user, or voluntarily. In the present embodiment, the information providing apparatus 100 including a function of the information processing apparatus 200 is assumed to be used in a limited space such as at a house of a user who makes a request to the information providing apparatus 100 for, for example, registration and provision of information, for example, as illustrated in FIG. 2.

Information provided to a user by the information providing apparatus 100 is any information, such as a schedule of a user that is associated with a calendar, a message such as an e-mail that is received by a user, a notification of any social network service (SNS), weather, traffic information, and information regarding a location of a restaurant, that can be acquired through the Internet. Further, the information providing apparatus 100 is also capable of playing back content such as music and video.

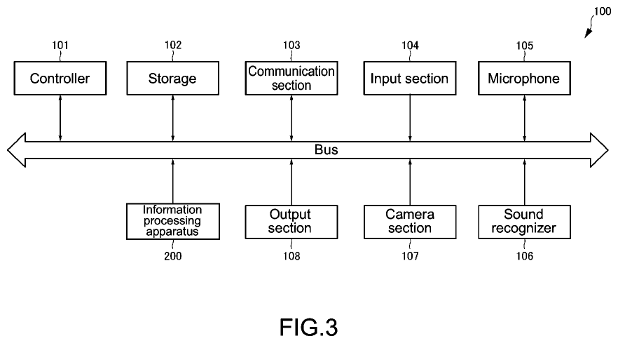

As illustrated in FIG. 3, the information providing apparatus 100 includes a controller 101, a storage 102, a communication section 103, an input section 104, a microphone 105, a sound recognizer 106, a camera section 107, an output section 108, and the information processing apparatus 200.

The controller 101 includes, for example, a central processing unit (CPU), a random access memory (RAM), and a read only memory (ROM). The CPU performs various processes in accordance with a program stored in the ROM and issues a command to perform an overall control on the information providing apparatus 100 and a control on each component of the information providing apparatus 100.

The storage 102 is, for example, a high-capacity storage medium such as a hard disk or a flash memory. The storage 102 stores therein various applications used in the information providing apparatus 100, various information input to the information providing apparatus 100 by a user, and the like. Confidential information communicated to the information providing apparatus 100 by a user using the present technology is also stored in the storage 102.

The communication section 103 is implemented by a communication module used to perform transmission and reception of data through the Internet, and to transmit data to and receive data from, for example, another apparatus. Communication may be performed using any method, such as a wireless local area network (LAN), a wide area network (WAN), wireless fidelity (Wi-Fi), the 4th generation mobile communication system (4G), and a broadband, that enables an Internet connection and a connection with another apparatus.

The input section 104 is used by a user to input various instructions to the information providing apparatus 100. When input to the input section 104 is performed by the user, a control signal corresponding to the input is generated to be supplied to the controller 101. Then, the controller 101 performs various processes corresponding to the control signal. The input section 104 may be, for example, a physical button, a touch panel, or a touch screen that is integrated with a monitor.

The microphone 105 records sound around the information providing apparatus 100, and supplies the sound recognizer 106 with the sound in the form of an input sound signal. Typically, a user uses his/her voice to input information to the information providing apparatus 100 such as a smart speaker or a communication robot, or to make a request to the information providing apparatus 100. Thus, the microphone 105 collects voice from a user.

The sound recognizer 106 analyzes a voice of a user that is input from the microphone 105, using an existing sound recognition algorithm, and recognizes details of input such as information and a request input by the user. The recognized information and request are supplied to the information processing apparatus 200.

The camera section 107 includes, for example, an imaging element and an image processing engine, and includes a function as a camera that can capture an image of the surroundings of the information providing apparatus 100.

The output section 108 is an output device used to provide information to a user. Examples of the output section 108 include a display and a monitor that display thereon, for example, an image, a video, and a graphical user interface (GUI); a projector that outputs, for example, an image, a video, and a GUI; a speaker that outputs sound; and a light-emitting diode (LED) that shows information using flashing light.

The information providing apparatus 100 has the configuration described above. The information providing apparatus 100 can recognize a voice from a user using the sound recognizer 106 to acquire information, and store the information in the storage 102. This enables a user to store, for example, his/her own schedule in the information providing apparatus 100 in the form of a note.

When the information providing apparatus 100 receives a request made by a user for information provision, the information providing apparatus 100 searches, for example, in information held in the storage 102 or in the Internet. When the information providing apparatus 100 acquires information that matches the request, the information providing apparatus 100 outputs the information using the output section 108 to provide the information to the user. Further, in response to a request from a user, the information providing apparatus 100 can provide the user with information input by the user to be stored in the information providing apparatus 100. When information that matches the request made by the user for information provision is not acquired, the information providing apparatus 100 notifies the user that the information has not been acquired using a message such as “No information” or “No idea”.

Note that it is assumed that, in the present embodiment, a user vocally inputs information to the information providing apparatus 100 and makes a request to the information providing apparatus 100 for information.

[1-2. Configuration of Information Processing Apparatus 200]

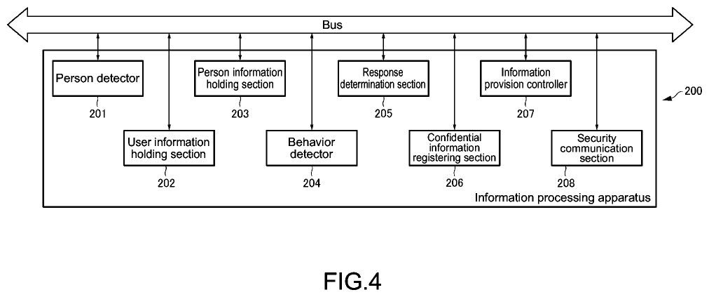

Next, a configuration of the information processing apparatus 200 is described. As illustrated in FIG. 4, the information processing apparatus 200 includes a person detector 201, a user information holding section 202, a person information holding section 203, a behavior detector 204, a response determination section 205, a confidential information registering section 206, an information provision controller 207, and a security communication section 208.

The person detector 201 detects who a person who makes a request to the information providing apparatus 100 is. The person detector 201 detects a person, for example, by a voiceprint recognition performed on the basis of sound from the microphone 105 included in the information providing apparatus 100, or by a subject recognition performed on the basis of an image or a video from the camera section 107 included in the information providing apparatus 100.

Further, the person detector 201 detects whether a person who makes a request to the information providing apparatus 100 is a registered user (such as an owner or a family member of the owner) of the information providing apparatus 100. Thus, it is necessary that the user information holding section 202 hold in advance information, such as information regarding a face of a registered user and information regarding a voiceprint of the registered user, that is necessary to specify a person. The person detector 201 compares the registered-user information to sound from the microphone 105, or to an image or a video from the camera section 107, and detects whether the person who makes a request to the information providing apparatus 100 is a registered user of the information providing apparatus 100.

It is necessary that information used to specify a registered user be input by a user of the information providing apparatus 100 to the user information holding section 202 in advance. Note that when the information providing apparatus 100 already holds the information used to specify a registered user, the information processing apparatus 200 may acquire the information from the information providing apparatus 100.

Further, the person detector 201 detects whether there is a person in a specified range that includes a location at which there exists the information providing apparatus 100. When there is a person in the specified range, the person detector 201 detects who the person is. A result of the detection performed by the person detector 201 is stored in the person information holding section 203. The person detector 201 continuously detects the presence or absence of a person in a space and who the person is, and updates information stored in the person information holding section 203 every time there is a change (including the case in which the person has disappeared from the space). Thus, the information held by the person information holding section 203 is real-time information.

Furthermore, when there is a person in the specified range that includes the location in which there exists the information providing apparatus 100, the person detector 201 may detect a distance between the person and the information providing apparatus 100 and whether the person keeps his/her face turned toward the information providing apparatus 100. These pieces of information are also held by the person information holding section 203. The distance between a person and the information providing apparatus 100 can be acquired using, for example, a distance recognition performed on the basis of an image or a video that is captured by the camera section 107, a distance recognition performed on the basis of sound collected by the microphone 105, or in-space map information obtained by simultaneous localization and mapping (SLAM). Further, whether a person keeps his/her face turned toward the information providing apparatus 100 can be determined by face recognition processing performed on an image or a video that is captured by the camera section 107.

The behavior detector 204 detects a specific behavior performed by a user when the user makes a request to the information providing apparatus 100. The behavior detector 204 detects the specific behavior of the user on the basis of sound from the microphone 105 included in the information providing apparatus 100 and an image or a video from the camera section 107 included in the information providing apparatus 100.

The response determination section 205 determines a response that is to be made by the information providing apparatus 100 to a request from a user, on the basis of a behavior made by the user when the user makes a request, the behavior being detected by the behavior detector 204, and on the basis of person information held by the person information holding section 203.

Examples of the response to be made by the information providing apparatus 100 to a request from a user include registration of confidential information (examples of the registration include registering information as confidential information and storing the information in the storage 102), provision of confidential information, stop of information provision, and normal provision of information. The confidential information is information that a user of the information providing apparatus 100 does not want a person other than the user, a specific person, or a person other than a specific person to know, and is information that is not output from the information providing apparatus 100 except in a special case or is limitedly output. The registration of confidential information is registering, on the information providing apparatus 100 and as confidential information, information that the user wants to register in a state of being kept secret. The provision of confidential information is outputting confidential information registered by the user on the information providing apparatus 100 in advance and providing the confidential information to the user.

The stop of information provision is stopping information from being provided by the information providing apparatus 100 in response to a request from the user. The stop of information provision is stopping halfway through provision of information when the information is being provided by the information providing apparatus 100 to the user. Note that the information provision in the stop of information provision includes not only provision of confidential information, but also provision of nonconfidential information other than confidential information.

There are several situations in which a user makes a request to stop information provision. Examples of such a situation include a situation in which a person whom a user does not want to know confidential information is approaching when the user is receiving the confidential information from the information providing apparatus 100 in a state in which there is no one but the user. In this case, the user makes a request that the information provision be stopped, in order to prevent the approaching person from knowing the confidential information.

Further, examples of such a situation include a situation in which confidential information is an event on a specific day, and a person whom a user does not want to know the confidential information is approaching when the user is receiving, from the information providing apparatus 100, a schedule for a week including the specific day. In this case, the information providing apparatus 100 can provide a schedule for the week from which the confidential information has been excluded. However, when the user is worried whether the confidential information is appropriately excluded, the user can stop information provision itself.

Furthermore, information provision can be stopped when confidential information is about to be provided by an erroneous detection performed by the behavior detector 204 of the information providing apparatus 100. It is assumed that a behavior performed by a user when the user makes a request that the information providing apparatus 100 provide confidential information is, for example, “approaching the information providing apparatus 100 while touching his/her ear with his/her hand”. In this case, when the user approaches the information providing apparatus 100 while scratching his/her ear, movement of the scratching his/her ear may be erroneously detected as movement of touching his/her ear with his/her hand, and provision of confidential information that is not expected by the user may be performed. A request that information provision be stopped is made when such an unexpected provision of confidential information is performed, and this makes it possible to stop confidential information from being provided due to erroneous detection if such a provision is started.

The normal provision of information is information provision performed by use of a normal function of the information providing apparatus 100.

A first example of a user's behavior that is associated with the registration of confidential information is user's communicating information to the information providing apparatus 100 in a low voice (a voice of volume equal to or lower than a specified volume). A second example of the user's behavior is communicating information after speaking a specific keyword to the information providing apparatus 100. Examples of the specific keyword include “this is a secret”, “keep it secret”, and “between you and me”. A third example of the user's behavior is communicating information to the information providing apparatus 100 while performing a specific behavior, or communicating information to the information providing apparatus 100 after performing a specific behavior. Examples of the specific behavior include speaking while raising the index finger in front of the face. Further, a fourth example of the user's behavior is talking to the information providing apparatus 100 from a specific direction. Examples of the specific direction include talking to the information providing apparatus 100 from behind. When one of those behaviors is detected by the behavior detector 204, it is determined that a request for registration of confidential information has been made by a user, and information communicated by the user when the user was performing the detected behavior is registered by the confidential information registering section 206 as confidential information.

A first example of a user's behavior that is associated with the provision of confidential information is approaching the information providing apparatus 100 while touching his/her ear with his/her hand. A second example of the user's behavior is speaking a specific keyword to the information providing apparatus 100. Examples of the specific keyword include “let me into a secret”.

When the response determination section 205 determines that a response to be made is registration of confidential information, the confidential information registering section 206 performs processing that includes registering information from a user as confidential information and storing the information in the storage 102 of the information providing apparatus 100. Note that confidential information is not limited to being stored in the storage 102 of the information providing apparatus 100. A storage used to store the confidential information may be provided to the information processing apparatus 200 and the confidential information may be stored in the provided storage.

A first example of a user's behavior that is associated with stop of information provision is giving a cough while putting his/her hand to his/her chin. A second example of the user's behavior is speaking a specific keyword to the information providing apparatus 100. Examples of the specific keyword include “stop speaking”.

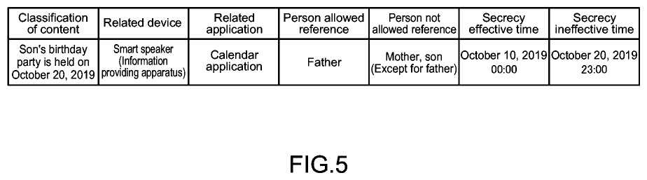

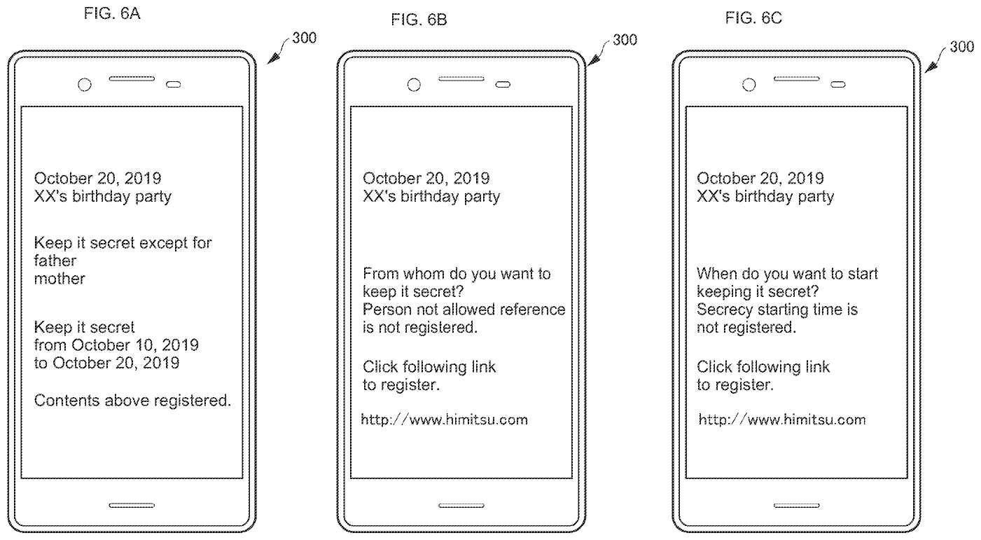

Confidential information is registered in the form of a plurality of items illustrated in FIG. 5. The items included in the confidential information are a classification of content, a related device, a related application, a person allowed reference, a person not allowed reference, a secrecy effective time, and a secrecy ineffective time.

A specific example in which, in a family of three that includes a father, a mother (a spouse of the father), and a son who are users of the information providing apparatus 100, the father registers “son's birthday party on Oct. 20, 2019” as confidential information, is described below. Note that it is assumed that the father, the mother, and the son have already been registered as registered users on the information providing apparatus 100, and pieces of information respectively used to specify the father, the mother, and the son are held by the user information holding section 202.

The classification of content in the items included in the confidential information indicates a specific content or type of the confidential information. In the example of FIG. 5, the classification of content indicates “son's birthday party”. The related device indicates an apparatus to which the confidential information is communicated by a user. When the user verbally communicates the confidential information directly to the information providing apparatus 100, which is a smart speaker, the related device is the smart speaker (the information providing apparatus 100). The related application indicates which of the applications operating in the information providing apparatus 100 the confidential information is associated with. In the example of FIG. 5, the confidential information is a future schedule that is “son's birthday party is held on Oct. 20, 2019” in which a date is specified. Thus, the related application is a calendar application. Note that, when information communicated by a user explicitly includes a schedule, the confidential information registering section 206 may automatically determine that the related application is a calendar and register the calendar as the related application. Further, when something is specifically designated by a user as the related application, such as “the related application is a calendar”, the confidential information registering section 206 may register it as the related application.

The person allowed reference indicates a person who is allowed to receive the confidential information, or a person who is allowed to know the confidential information. On the basis of a result of detection performed by the person detector 201, the detection being detection of who has made a request that the confidential information be registered, the confidential information registering section 206 registers, as the person allowed reference, at least a person who has made the request that the confidential information be registered. In the example of FIG. 5, the father himself having made a request that the confidential information be registered, is the person allowed reference. Note that the person allowed reference includes not only a person who can receive confidential information from the information providing apparatus 100 by making a request to the information providing apparatus 100 for the confidential information, but also a person who does not make a request to the information providing apparatus 100 for confidential information but is allowed to hear and know the confidential information provided by the information providing apparatus 100 to another person.

The person not allowed reference indicates a person who is not allowed to receive the confidential information from the information providing apparatus 100, or a person who is not allowed to know the confidential information. The person not allowed reference includes not only a person who has made a request to the information providing apparatus 100 for confidential information but is not allowed to receive the confidential information, but also a person who has not made a request to the information providing apparatus 100 for confidential information, and is not allowed to hear and know the confidential information at the moment of the confidential information being provided by the information providing apparatus 100 to another person. Information regarding the person allowed reference and the person not allowed reference corresponds to referring-person information according to an embodiment of the present technology. When a request for information provision is made, the information processing apparatus 200 confirms whether a person who has made the request is a person allowed reference or a person not allowed reference, on the basis of a result of detection performed by the person detector 201 and referring-person information. The information processing apparatus 200 provides the information to the person when the person is a person allowed reference, and does not provide the information to the person when the person is a person not allowed reference. It is assumed that, in the example of FIG. 5, “father, mother, son” is set to be the “entirety of a range covered by the information processing apparatus 200” in advance. With respect to the “entirety of a range covered by the information processing apparatus 200”, the information processing apparatus 200 may automatically determine, with no change, a registered user of the information providing apparatus 100 as the entirety of the covered range, or the user may define the “entirety of a range covered by the information processing apparatus 200” and may set the definition in advance. Then, on the basis of information that is “son's birthday party on October 20, 2019” provided by a speech of the father (a user), the son for whom the birthday party is held is determined to be a person not allowed reference. The father is a person who spoke, and thus is automatically determined to be a person allowed reference. Further, the mother who is a person other than a person for whom the birthday party is held and a person who spoke, is automatically determined to be a person not allowed reference. The reason is that confidential information can be kept secret with certainty when a person who is not clearly determined to be a person allowed reference or a person not allowed reference, is determined to be a person not allowed reference.

In the example of FIG. 5, all people except for the father who has communicated confidential information to the information providing apparatus 100, and the mother are set to be persons not allowed reference. Here, the confidential information is “son's birthday party”. Thus, in order for a third party to not get to know about the confidential information and to not let the son know about the confidential information, all people except for the father and the mother are set to be persons not allowed reference, where the son is included in the person not allowed reference. Note that, when a person other than a specific person is set to be the person not allowed reference using the definition “except for”, as described above, all human beings belong to a person allowed reference or a person not allowed reference.

It is favorable that a user explicitly communicate who is the person not allowed reference to the information providing apparatus 100 upon communicating information to the information providing apparatus 100, in order to register the person not allowed reference with certainty. Further, when confidential information is “son's birthday party on Oct. 20, 2019”, the confidential information registering section 206 may determine that the son is not to be notified of the confidential information, and may register the son as a person not allowed reference.

The secrecy effective time indicates a date and time for starting keeping confidential information secret. The secrecy ineffective time indicates a date and time for stopping keeping confidential information secret. Note that, when there is no secrecy effective time, that is, when confidential information starts being kept secret at the time at which the confidential information is registered on the information providing apparatus 100, “at once, N/A, or blank” may be set to be the secrecy effective time. Further, when there is no secrecy ineffective time, that is, when confidential information remains kept secret, “N/A, blank, or indefinite” may be set to be the secrecy ineffective time. The secrecy effective time and the secrecy ineffective time may be represented by a single item “secrecy period of time” that indicates a period of time for which confidential information is treated as secret.

It is favorable that a user explicitly communicate the secrecy effective time and the secrecy ineffective time to the information providing apparatus 100 upon communicating information to the information providing apparatus 100, in order to register the secrecy effective time and the secrecy ineffective time with certainty. Further, when confidential information is “son's birthday party on Oct. 20, 2019”, and when the sound recognizer 106 recognizes a future date “Oct. 20, 2019”, the confidential information registering section 206 may determine that this information is to be kept secret at least for a period of time from registration of the information to Oct. 20, 2019, and may register the secrecy effective time and the secrecy ineffective time. The secrecy effective time corresponds to first time information according to an embodiment of the present technology, and the secrecy ineffective time corresponds to second time information according to an embodiment of the present technology.

Confidential information is registered as described above. Thus, it is favorable that a user who intends to register confidential information communicate, to the information providing apparatus 100, the date, the person allowed reference, the person not allowed reference, the secrecy effective time, and the secrecy ineffective time together with the classification of content of the confidential information.

For example, it is necessary that a user communicate, to the information providing apparatus 100, information indicating “Son's birthday party is held on October 20. Keep it secret except for father and mother. Keep it secret for a period of time from October 10 to October 20.”

Note that, when information indicating that “son's birthday party is held on October 20” is communicated by, for example, artificial intelligence or deep learning, the confidential information registering section 206 may recognize that there is a need to keep the confidential information secret from at least the son, and information is to be kept secret for a period of time from completion of registration of the information to the end of the birthday party, and then the confidential information registering section 206 may register the person not allowed reference, the secrecy effective time, and the secrecy ineffective time. Consequently, a user does not have to verbally communicate, to the information providing apparatus 100, all of the items included in confidential information, and this results in a quick and easy registration of confidential information.

The specific behaviors respectively associated with the registration of confidential information, the provision of confidential information, and the stop of information provision are not limited to the examples described above. Any behaviors respectively associated with them are acceptable. Note that, with respect to the specific keywords, the specific behaviors, and the specific direction described above, it is necessary that a user register any keyword, any behavior, and any direction on the information processing apparatus 200 in advance. Further, the manufacturer of the information providing apparatus 100 or the information processing apparatus 200 may register a specific keyword, a specific behavior, and a specific direction as default prior to shipment, and may let a user know about them using, for example, a manual to encourage the user to use them.

Return to the description of the block diagram in FIG. 4. The information provision controller 207 controls provision of confidential information to a user that is performed by the information providing apparatus 100 when the response determination section 205 determines that a response to be made by the information providing apparatus 100 is provision of confidential information. The provision of confidential information to a user is described in detail later.

The security communication section 208 performs communication processing. When information communicated by a user has been registered as confidential information, the communication processing is performed to notify the user of the registration using a specified communication method. Communication is performed by the communication section 103 of the information providing apparatus 100.

In the present technology, when information communicated to the information providing apparatus 100 by a user has been registered as confidential information, the information providing apparatus 100 outputs a voice message such as “all right” without including details of the confidential information to notify the user that the information has been registered. The reason is that, when the user is notified, by the confidential information being repeated by voice, that confidential information has been registered, there is a possibility that a person whom the user does not want to know the confidential information will hear the voice and know the information. When a user is notified that confidential information has been registered, using, for example, “all right” without including details of the information, this makes it possible to notify the user that the confidential information has been registered, without a person other than the user knowing the confidential information.

However, only with a voice message, such as “all right”, that does not include confidential information, it is difficult for a user to confirm whether the information is accurately registered on the information providing apparatus 100. Thus, instead of outputting a voice message from the information providing apparatus 100, content of information registered as confidential information is transmitted to a user by a method only recognizable to the user. Examples of the method only recognizable to the user include transmission of an e-mail, and transmission of a message using a message application. This enables a user to know that information is accurately registered on the information providing apparatus 100 as confidential information.

Further, the same applies to the case of notifying a user that confidential information has been registered, by a method that enables visual recognition such as displaying on a display. The reason is that, when the user is notified, by the confidential information being displayed on a display, that registration of confidential information has been completed, there is a possibility that a person whom the user does not want to know the confidential information will see the display and know the information. Thus, also in such a case, a user is notified that confidential information has been registered, by, for example, “all right” being displayed without including details of the information. Then, content of the information registered as confidential information is transmitted to the user by a method only recognizable to the user. This makes it possible to notify the user that the confidential information has been registered, without a person other than the user knowing the confidential information.

For example, as illustrated in A of FIG. 6, a notification of completion of registration of confidential information is transmitted together with content of the confidential information to a terminal apparatus 300 (such as a smartphone) of a user by a message. Accordingly, only the user knows that the confidential information has been accurately registered.

Further, when there is a missing item from among the above-described items included in confidential information, the security communication section 208 notifies a user of the missing item by a method only recognizable to the user to encourage the user to add the missing item.

For example, when the person not allowed reference is not registered due to, for example, it not being input by a user or it not being recognized by the sound recognizer 106 of the information providing apparatus 100, a message used to encourage registration of the person not allowed reference is transmitted to the smartphone of the user, as illustrated in B of FIG. 6. Further, when the secrecy starting time is not registered, a message illustrated in C of FIG. 6 is transmitted to the smartphone of the user to encourage registration. Note that the method for registration of unregistered information that is performed by a user may be a method that includes presenting a link illustrated in B or C of FIG. 6 and transmitting input information to the information providing apparatus 100 through, for example, a server, or may be a method that includes directly communicating information to the information providing apparatus 100.

The information providing apparatus 100 and the information processing apparatus 200 have the configurations described above. The information processing apparatus 200 is implemented by a program. The program may be installed on the information providing apparatus 100 in advance, or may be distributed, for example, by being downloaded or on a storage medium to be installed by a user himself/herself on the information providing apparatus 100. Further, the information processing apparatus 200 is not limited to being implemented by a program, and may be implemented by combining a dedicated apparatus and a dedicated circuit that include hardware including a function of the program.

Furthermore, the information processing apparatus 200 is included in a server, and may receive, from the information providing apparatus 100, information from a user through a network, and may register the received information on the server as confidential information. In this case, the information processing apparatus 200 may also receive sound from the microphone 105 and an image or a video from a camera through a network to determine a response, and may perform control such that the information providing apparatus 100 makes the response.

[1-3. Processing Performed by Information Processing Apparatus 200]

[1-3-1. Processing Performed in Response to Request from User]

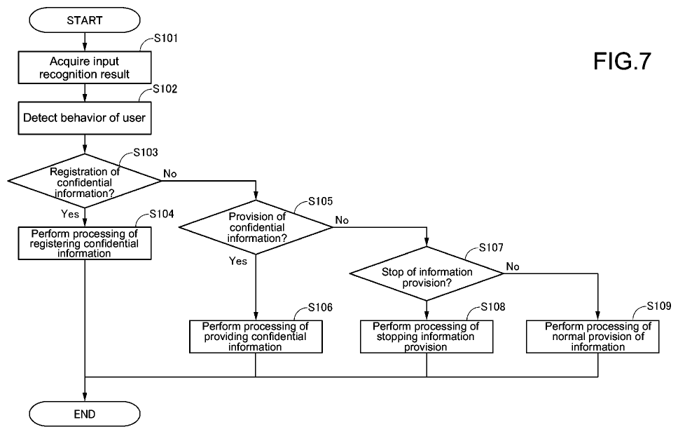

Next, processing performed by the information processing apparatus 200 is described. A flowchart of FIG. 7 is a flowchart illustrating processing performed by the information processing apparatus 200 when a request from a user is received.

First, in Step S101, the information processing apparatus 200 acquires, from the sound recognizer 106, a result of recognizing a sound input performed by a user. Next, in Step S102, the behavior detector 204 detects a behavior performed by the user when the sound input is performed. Note that the processes of Steps S101 and S102 are performed at substantially the same time.

Next, in Step S103, the response determination section 205 determines whether the request from the user is a request that confidential information be registered. The determination is performed on the basis of the behavior of the user at the time of the sound input, the behavior being detected by the behavior detector 204. When the behavior of the user at the time of the sound input is associated with registration of confidential information, the response determination section 205 determines that the request from the user is a request that confidential information be registered, and determines that a response that is to be made to the request from the user is registration of confidential information. Then, the process moves on to Step S104 (Yes in Step S103). Then, in Step S104, information communicated by the user is registered by the confidential information registering section 206 as confidential information.

On the other hand, when the request from the user is not the request that confidential information be registered, the process moves on to Step S105 from Step S103 (No in Step S103), and the response determination section 205 determines whether the request from the user is a request that confidential information be provided.

When the behavior of the user at the time of the sound input is associated with provision of confidential information, the response determination section 205 determines that the request from the user is a request that confidential information be provided, and determines that a response that is to be made to the request from the user is provision of confidential information. Then, the process moves on to Step S106 (Yes in Step S105). Then, in Step S106, confidential information is provided in response to the request from the user by control being performed by the information provision controller 207.

On the other hand, when the request from the user is not the request that confidential information be provided, the process moves on to Step S107 from Step S105 (No in Step S105), and the response determination section 205 determines whether the request from the user is a request that information provision be stopped.

When the behavior of the user at the time of the sound input is associated with stop of information provision, the response determination section 205 determines that a response that is to be made to the request from the user is stop of information provision, and the process moves on to Step S108 (Yes in Step S107). Then, in Step S108, information provision performed by the information providing apparatus 100 is stopped by control being performed by the information provision controller 207. Note that the stop of information provision is stopping halfway through provision of information when the information is being provided by the information providing apparatus 100 to the user.

On the other hand, when the request from the user is not the request that information provision be stopped, the response determination section 205 determines that a response that is to be made to the request from the user is normal provision of information (information other than confidential information), and the process moves on to Step S109 (No in Step S107). Then, information is provided by the information providing apparatus 100 in Step S109.

[1-3-2. Processing of Registering Confidential Information]

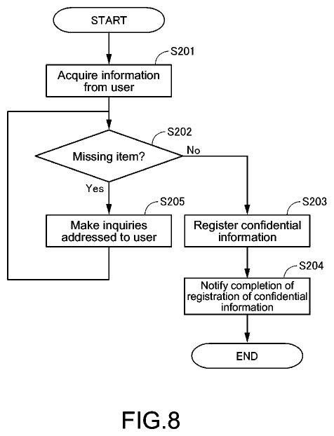

Next, processing of registering confidential information that is performed by the confidential information registering section 206 is described with reference to a flowchart of FIG. 8. The registered confidential information is stored in the storage 102 of the information providing apparatus 100. Note that the information processing apparatus 200 may include its own storage medium, and confidential information may be stored in the storage medium.

First, in Step S201, the confidential information registering section 206 acquires, from the sound recognizer 106, information that is a result of recognizing a sound input performed by a user.

Next, in Step S202, the confidential information registering section 206 determines whether the information from the user has a missing item from among items included in confidential information. When there is a missing item from among the respective items included in the confidential information and described with reference to FIG. 5, it is determined that the information from the user has a missing item, and when there is no missing item, it is determined that the information from the user has no missing item.

When it has been determined that the information from the user has no missing item, the process moves on to Step S203, and the confidential information registering section 206 performs processing that includes registering the confidential information and storing the confidential information in the storage 102. Next, in Step S204, the security communication section 208 transmits a notification of completion of registration of confidential information to the user. The notification of completion of registration is, for example, the message illustrated in A of FIG. 6.

On the other hand, when it has been determined, in Step S202, that the information from the user has a missing item from among the items of the confidential information, the process moves on to Step S205 (Yes in Step S202), and the security communication section 208 makes inquiries addressed to the user. The inquiries addressed to the user are made by, for example, transmitting the message illustrated in B or C of FIG. 6.

After the inquiries, it is determined again, in Step S202, whether the information from the user has a missing item from among the items of the confidential information. When it has been determined that the information from the user has no missing item, the confidential information is registered in Step S203, and completion of registration of the confidential information is notified in Step S204.

Note that, when a missing piece of information is still not added after a certain period of time has elapsed since inquiries were made addressed to a user, or when the missing piece of information is still not added after the inquiries are made a certain number of times, confidential information having the missing piece of information may be registered.

[1-3-3. Processing of Limitedly Providing Information]

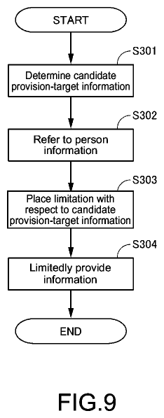

Next, a limited provision of information that is an example of information provision in normal provision of information in Step S109 of the flowchart of FIG. 7, is described with reference to a flowchart of FIG. 9.

The information provision in Step S109 is not provision of confidential information, but information provision performed in a normal use of the information providing apparatus 100. In this case, output of confidential information that is not expected by a user may be performed. For example, when the father who is a user registers “son's birthday party is held on October 20” as confidential information and when the father makes a request, “Let me know my schedule in October”, the confidential information “son's birthday party on October 20” is output by the information providing apparatus 100 together with other plans in the schedule in October. Then, if there is the son near the father, the confidential information will be known to the son who is not to be notified of the confidential information.

Here, the limited provision of information is processing of limitedly providing information such that a person not allowed reference does not get to know confidential information when information is provided in response to a request made by a user that normal provision of information be performed.

First, in Step S301, the information provision controller 207 determines candidate provision-target information. The candidate provision-target information is all of the pieces of information provided in response to a request made by a user for information provision, and no limitation has not been placed. Thus, the candidate provision-target information is not information that is to be ultimately provided to the user. In this example, the description is made on the assumption that the confidential information is “son's birthday party on October 20”, and a request from the father who is a user is a request for “father's schedule in October”.

Next, in Step S302, the information provision controller 207 refers to the person information holding section 203, and confirms whether there is now a person in a specified range that includes a location at which there exists the information providing apparatus 100. When it has been determined that there is now a person in the specified range, the information provision controller 207 confirms who the person is. Next, in Step S303, the information provision controller 207 performs limitation placement processing with respect to candidate provision-target information on the basis of information held by the person information holding section 203. The limitation placement processing with respect to candidate provision-target information is processing of placing a limitation on information provision by, for example, editing candidate provision-target information or determining a method for outputting information.

The editing candidate provision-target information is generating information that is to be ultimately provided to a user, by, for example, excluding confidential information from the candidate provision-target information, or changing confidential information in the candidate provision-target information to information with broader terms.

The following case is discussed. The father who is a user has made a request that information that is “father's schedule in October” be provided, and it has been confirmed, by referring to the person information holding section 203, that there is the son near the father. In this case, the candidate provision-target information is “all of father's schedule in October”. However, there is the son near the father, and thus a father's schedule in October obtained by excluding “son's birthday party on October 20” from “all of father's schedule in October” corresponds to the information to be ultimately provided to the father. This makes it possible to respond to a request made by the father for information provision without the son knowing confidential information.

The determining a method for outputting information is, for example, making a volume of sound low (setting a volume of sound such that the volume exhibits a value equal to or smaller than a specified value) when information is provided by the information providing apparatus 100 to a user using the sound.

The following case is discussed. The father who is a user has made a request that information that is “father's schedule in October” be provided, and it has been confirmed, by referring to the person information holding section 203, that there is the son near the father. In this case, the candidate provision-target information is “all of father's schedule in October”. However, there is the son near the father. Thus, when information that is “all of father's schedule in October” is provided, a volume of sound used by the information providing apparatus 100 is made low upon outputting confidential information that is “son's birthday party on October 20”. This method is effective when, for example, there is the son near the father, but the son is away from the information providing apparatus 100 at a distance equal to or greater than a specified distance and the son does not keep his face turned toward the information providing apparatus 100. In such a case, information can be provided to the father at a low volume without the son hearing confidential information.

Further, when information is provided by an image or a video being displayed, the display period of time may be made short (may be made equal to or shorter than a specified period of time), the display may be made dark, or effects may be applied to a portion of confidential information in the displayed information such that it becomes difficult to see the portion.

Then, in Step S304, information is provided to the information providing apparatus 100, and the information is limitedly provided by the information providing apparatus 100 to the user.

As described above, confidential information is registered and provided according to the present technology. The present technology enables a user to register confidential information on the information providing apparatus 100 without other people knowing the confidential information, and to receive confidential information without other people knowing the confidential information. Further, the present technology enables a user to stop provision of confidential information when the user feels that other people may know the confidential information by information provision being performed by the information providing apparatus 100. This makes it possible to prevent the confidential information from being known to other people. Furthermore, a user knows, by a method only recognizable to the user, that the information providing apparatus 100 has accurately registered thereon confidential information.

Accordingly, a user can confirm that confidential information has been registered with certainty without being worried whether the confidential information has been accurately registered.

[1-3-4. Diversion of Confidential Information]

Next, diversion of confidential information for the information providing apparatus 100 including the information processing apparatus 200 to a use for another apparatus is described. The other apparatus is a so-called Internet of Things (IoT) device that includes a function of establishing an Internet connection. An example in which the IoT device is a refrigerator 400, and, as described above, confidential information registered by the father who is a user is son's birthday party, is described in the present embodiment.

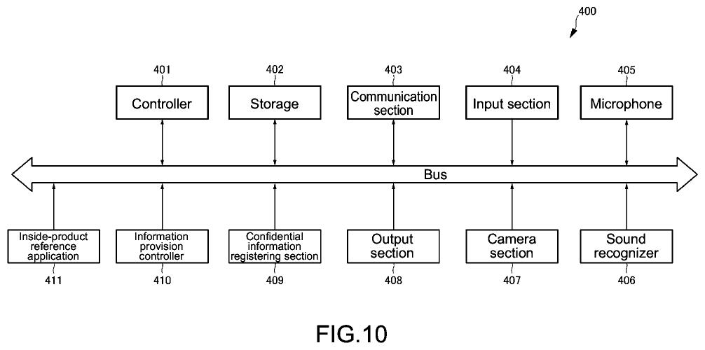

As illustrated in FIG. 10, the refrigerator 400 includes a controller 401, a storage 402, a communication section 403, an input section 404, a microphone 405, a sound recognizer 406, a camera section 407, and an output section 408. Each of those components includes the same function as a corresponding component described with reference to FIG. 4.

Further, the refrigerator 400 includes at least a confidential information registering section 409 and an information provision controller 410 that are similar to those included in the information processing apparatus 200. The confidential information registering section 409 registers, as confidential information, diversion information received through the communication section 403, and is similar to the confidential information registering section 206 described above. The information provision controller 410 controls information provision performed by the refrigerator 400 in response to a request made by a user for information provision, and is similar to the information provision controller 207 described above. Note that the refrigerator 400 may include all of the functions that are similar to functions of the information processing apparatus 200.

Furthermore, the refrigerator 400 includes an inside-product reference application 411, and can generate product reference information that indicates a product in the refrigerator 400. For example, the product reference information indicating a product in the refrigerator 400 may be generated on the basis of image recognition performed on an image of the inside of the refrigerator 400 that is captured by a camera placed in the refrigerator, and/or on the basis of input performed by a person. When a user of the refrigerator 400 makes a request, by, for example, sound, that the refrigerator 400 provide product reference information, the product reference information generated by the inside-product reference application 411 is output from the output section 408 to be provided to the user. Further, when the user is away from the refrigerator 400 such as being outdoors, and when the user makes a request, by a specified method for communication performed through the Internet using, for example, an e-mail, that product reference information be provided, the product reference information is transmitted from the communication section 403 to a terminal apparatus such as a smartphone of the user.

Further, the refrigerator 400 including a portion of or all of the configuration according to the present technology associates product reference information generated by the inside-product reference application 411 with confidential information, and the refrigerator 400 provides the product reference information from which the confidential information has been excluded when a person who is not allowed to refer to the confidential information makes a request for the product reference information.

The case in which the father registers “son's birthday party” on the information providing apparatus 100 as confidential information, and then a birthday cake is put in the refrigerator 400, is discussed. When the son makes a request that product reference information regarding the refrigerator 400 be transmitted in order to know food placed in the refrigerator 400, the son will know that the birthday cake to be kept secret from the son is prepared if the product reference information includes the cake.

Thus, the cake is treated as confidential information for the refrigerator 400, and product reference information from which the cake has been excluded is provided in response to a request from the son. Accordingly, the son is not aware that there is the cake, and thus the son is not aware that his birthday party is planned.

The cake is a cake for “son's birthday party”, which is confidential information for the information providing apparatus 100. Thus, a person allowed reference, a person not allowed reference, a secrecy effective time, and a secrecy ineffective time that are items included in confidential information that is to be registered on the refrigerator 400, are the same as the confidential information “son's birthday party” registered on the information providing apparatus 100. Thus, in the present technology, the confidential information “son's birthday party” registered on the information providing apparatus 100 in advance is diverted to be shared with the refrigerator 400. This makes it possible to easily register, on another apparatus, confidential information that is related to the confidential information registered on the information providing apparatus 100. Note that, from among items included in information related to the confidential information “cake” for the refrigerator 400, an item “related apparatus” is the refrigerator 400, and an item “related application” is the inside-product reference application 411.

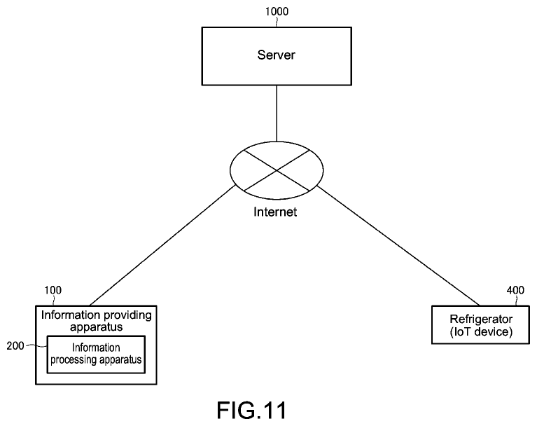

Information can be diverted by various methods. First, as illustrated in FIG. 11, the refrigerator 400 that is an IoT device, the information providing apparatus 100, and a server 1000 are connected to each other through the Internet to create an information diversion system. Further, the information providing apparatus 100 and the refrigerator 400 are registered on the server 1000 in advance.

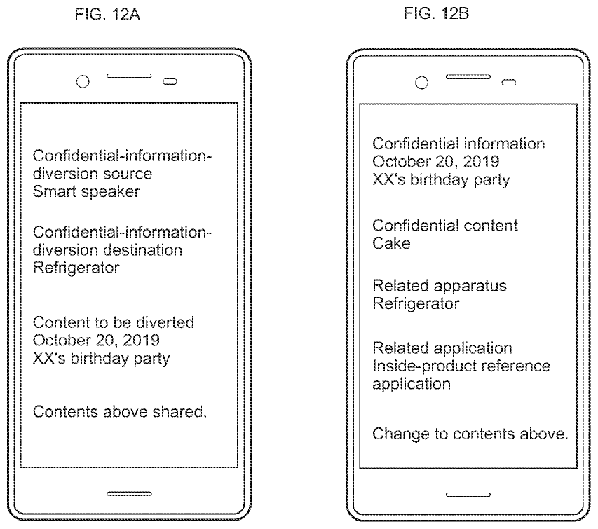

Further, a dedicated website that enables data transmission from the information providing apparatus 100 to the server 1000 is provided by, for example, a manufacturer of the information providing apparatus 100. Then, on the dedicated website, using a smartphone as illustrated in A of FIG. 12, a user specifies the information providing apparatus 100 (for example, a smart speaker) as an information-diversion source, specifies an IoT device (the refrigerator 400) as an information-diversion destination, specifies the confidential information “son's birthday party” registered on the information providing apparatus 100 as confidential information to be diverted, and instructs the server 1000 to divert the confidential information.

Furthermore, as illustrated in B of FIG. 12, an instruction to change the classification of content from the confidential information “son's birthday party” to “cake”, to change the related apparatus to the “refrigerator 400”, and to change the related application to “inside-product reference application” is transmitted to the server 1000, using the dedicated website.

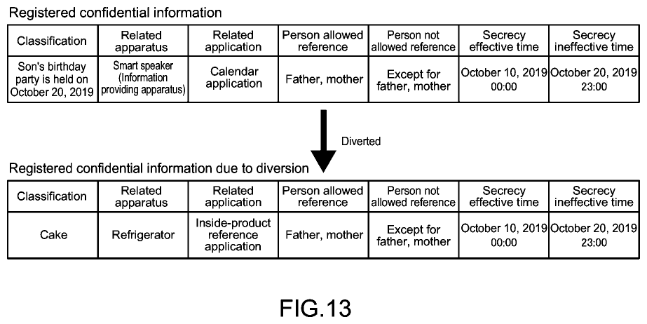

Then, the server 1000 having received the instruction acquires the confidential information from the information providing apparatus 100, and supplies the acquired confidential information to the refrigerator 400. Accordingly, information related to the confidential information “son's birthday party” registered on the information providing apparatus 100 can be diverted to a use for the confidential information “cake” for the refrigerator 400, and shared with the refrigerator 400, as illustrated in FIG. 13.

Note that the refrigerator 400 has been described above as an example of the IoT device. However, any apparatus that includes a function of establishing an Internet connection and is capable of performing transmission and reception of information may be adopted as the other apparatus. Examples of the other apparatus include a smartphone, a personal computer, a tablet terminal, a camera, a wearable device, a smart speaker, a game device, a server apparatus, a pet/humanoid robot capable of establishing an Internet connection, and various sensor apparatuses.

Note that confidential information may be diverted by being directly transmitted from the information providing apparatus 100 to the IoT device without using the server 1000. In this case, it is necessary for a user to set, in the information providing apparatus 100, an information-diversion destination, an information-diversion source, and diversion-destination information.

Further, when the information providing apparatus 100 and the IoT device are connected to each other through the Internet, confidential information may be diverted according to an instruction, such as “a cake in the refrigerator 400 is to be kept secret from the son”, that is given by a user to the information providing apparatus 100, and specifies the confidential information and a diversion destination of the confidential information.

Furthermore, confidential information is not limited to being diverted to a use for an apparatus other than the information providing apparatus 100 and shared with the other apparatus, and confidential information for an application from among a plurality of applications included in the information providing apparatus 100 can also be diverted to a use for another application from among the plurality of applications, and shared with the other application. Examples of such a diversion include diverting confidential information including a “calendar application” as the related application to a use for a note application or a message application that runs on the same information providing apparatus 100.

As described above, the diversion of confidential information results in there being no need to respectively register pieces of confidential information on a plurality of apparatuses. This makes it possible to omit some registration processes. Further, when pieces of confidential information are respectively registered on a plurality of apparatuses, different contents may be registered with respect to the same confidential information. However, such a problem does not occur with diversion. Furthermore, the confidentiality of confidential information can be ensured with certainty by the confidential information being shared by a plurality of apparatuses.

<2. Modifications>

The embodiments of the present technology have been described above in detail. However, the present technology is not limited to the embodiments described above, and various modifications based on the technical idea of the present technology may be made thereto.

Any apparatus that is capable of recognizing a request from a user, registering and storing information, and providing the information to the user may be adopted as the information providing apparatus 100. Examples of the information providing apparatus 100 include a stationary personal computer, a notebook computer, a smartphone, and a tablet terminal in addition to a stationary smart speaker and a communication robot.

A space in which the information providing apparatus 100 is used is not limited to a house, and may be a space such as a company or a school.

In the embodiments, a user inputs information to the information providing apparatus 100 using a sound input. However, information is not limited to being input by sound, and information may be input, for example, by presentation of a character written, for example, on paper or on a board, by sign language, or by a gesture. The recognition of, for example, a character, sign language, or a gesture of which an image is captured by the camera section 107 makes it possible to input information to the information providing apparatus 100 and register the information as confidential information without using sound.

The present technology may also take the following configurations.
(1) An information processing apparatus, including:

a behavior detector that detects a behavior performed by a user when the user makes a request to an information providing apparatus with respect to information from the user; and

a response determination section that determines a response to be made by the information providing apparatus to the request.
(2) The information processing apparatus according to (1), in which

the response is registering the information from the user as confidential information.
(3) The information processing apparatus according to (2), in which

when the behavior detector detects a behavior that is associated in advance with the registering the information from the user as confidential information, the response is determined to be the registering the information from the user as confidential information.
(4) The information processing apparatus according to any one of (1) to (3), in which

the response is providing the confidential information registered in advance.
(5) The information processing apparatus according to (4), in which

when the behavior detector detects a behavior that is associated in advance with the providing the confidential information, the response is determined to be the provision of the confidential information being performed by the information providing apparatus.
(6) The information processing apparatus according to any one of (1) to (5), in which

the response is stopping information from being provided by the information providing apparatus.
(7) The information processing apparatus according to (6), in which

when the behavior detector detects a behavior that is associated in advance with the stopping information from being provided, the response is determined to be the stopping information from being provided by the information providing apparatus.
(8) The information processing apparatus according to (2), in which

the information from the user is registered as the confidential information in association with referring-person information that indicates a person who is allowed to refer to the information from the user, and a person who is not allowed to refer to the information from the user.
(9) The information processing apparatus according to (8), further including

a person detector that detects that there is a person in a specified range that includes a location at which the information providing apparatus is placed, in which

how the confidential information is to be provided is determined on the basis of a result of the detection performed by the person detector and the referring-person information.
(10) The information processing apparatus according to (9), in which

when the person detected by the person detector is the person allowed to refer to the confidential information, the response is determined to be provision of the confidential information to the user that is performed by the information providing apparatus.
(11) The information processing apparatus according to (9) or (10), in which

when the person detected by the person detector is the person not allowed to refer to the confidential information, the response is determined to be not providing the confidential information to the user.
(12) The information processing apparatus according to (9), in which

when the person detected by the person detector is the person not allowed to refer to the confidential information, the response is determined to be limitedly providing the confidential information to the user.
(13) The information processing apparatus according to (12), in which

when the confidential information is provided by the information providing apparatus using sound, the limited provision is performing setting such that a volume of the sound is equal to or lower than a specified volume.
(14) The information processing apparatus according to (12), in which

when the confidential information is provided by the information providing apparatus by an image or a video being displayed, the limited provision is performing setting such that a period of time of the display is equal to or shorter than a specified period of time.
(15) The information processing apparatus according to (2), in which

the confidential information is registered in association with first time information that indicates a point in time for starting keeping the confidential information secret.
(16) The information processing apparatus according to (2), in which

the confidential information is registered in association with second time information that indicates a point in time for stopping keeping the confidential information secret.
(17) The information processing apparatus according to (2), in which

the confidential information is usable by being diverted to a use for an apparatus other than the information providing apparatus.
(18) The information processing apparatus according to (2), in which

the confidential information is usable by being diverted to a use for an application other than an application that is included in the information providing apparatus and related to the confidential information.
(19) An information processing method, including:

detecting a behavior performed by a user when the user makes a request to an information providing apparatus with respect to information from the user; and

determining a response to be made by the information providing apparatus to the request.
(20) An information processing program that causes a computer to perform an information processing method including:

detecting a behavior performed by a user when the user makes a request to an information providing apparatus with respect to information from the user; and

determining a response to be made by the information providing apparatus to the request.

### REFERENCE SIGNS LIST

100 information providing apparatus
200 information processing apparatus
201 person detector
204 behavior detector
205 response determination section

1. An information processing apparatus, comprising:
a behavior detector that detects a behavior performed by a user when the user makes a request to an information providing apparatus with respect to information from the user; and
a response determination section that determines a response to be made by the information providing apparatus to the request.

2. The information processing apparatus according to claim 1, wherein
the response is registering the information from the user as confidential information.

3. The information processing apparatus according to claim 2, wherein
when the behavior detector detects a behavior that is associated in advance with the registering the information from the user as confidential information, the response is determined to be the registering the information from the user as confidential information.

4. The information processing apparatus according to claim 1, wherein
the response is providing the confidential information registered in advance.

5. The information processing apparatus according to claim 4, wherein
when the behavior detector detects a behavior that is associated in advance with the providing the confidential information, the response is determined to be the provision of the confidential information being performed by the information providing apparatus.

6. The information processing apparatus according to claim 1, wherein
the response is stopping information from being provided by the information providing apparatus.

7. The information processing apparatus according to claim 6, wherein
when the behavior detector detects a behavior that is associated in advance with the stopping information from being provided, the response is determined to be the stopping information from being provided by the information providing apparatus.

8. The information processing apparatus according to claim 2, wherein
the information from the user is registered as the confidential information in association with referring-person information that indicates a person who is allowed to refer to the information from the user, and a person who is not allowed to refer to the information from the user.

9. The information processing apparatus according to claim 8, further comprising
a person detector that detects that there is a person in a specified range that includes a location at which the information providing apparatus is placed, wherein
how the confidential information is to be provided is determined on a basis of a result of the detection performed by the person detector and the referring-person information.

10. The information processing apparatus according to claim 9, wherein
when the person detected by the person detector is the person allowed to refer to the confidential information, the response is determined to be provision of the confidential information to the user that is performed by the information providing apparatus.

11. The information processing apparatus according to claim 9, wherein
when the person detected by the person detector is the person not allowed to refer to the confidential information, the response is determined to be not providing the confidential information to the user.

12. The information processing apparatus according to claim 9, wherein
when the person detected by the person detector is the person not allowed to refer to the confidential information, the response is determined to be limitedly providing the confidential information to the user.

13. The information processing apparatus according to claim 12, wherein
when the confidential information is provided by the information providing apparatus using sound, the limited provision is performing setting such that a volume of the sound is equal to or lower than a specified volume.

14. The information processing apparatus according to claim 12, wherein
when the confidential information is provided by the information providing apparatus by an image or a video being displayed, the limited provision is performing setting such that a period of time of the display is equal to or shorter than a specified period of time.

15. The information processing apparatus according to claim 2, wherein
the confidential information is registered in association with first time information that indicates a point in time for starting keeping the confidential information secret.

16. The information processing apparatus according to claim 2, wherein
the confidential information is registered in association with second time information that indicates a point in time for stopping keeping the confidential information secret.

17. The information processing apparatus according to claim 2, wherein
the confidential information is usable by being diverted to a use for an apparatus other than the information providing apparatus.

18. The information processing apparatus according to claim 2, wherein
the confidential information is usable by being diverted to a use for an application other than an application that is included in the information providing apparatus and related to the confidential information.

19. An information processing method, comprising:
detecting a behavior performed by a user when the user makes a request to an information providing apparatus with respect to information from the user; and
determining a response to be made by the information providing apparatus to the request.

20. An information processing program that causes a computer to perform an information processing method comprising:
detecting a behavior performed by a user when the user makes a request to an information providing apparatus with respect to information from the user; and
determining a response to be made by the information providing apparatus to the request.
